(19) United States
(12) Patent Application Publication
(10) Pub. No.: US 2025/0346189 A1
(43) Pub. Date: Nov. 13, 2025

(54) Vehicular Trunk Reception Structure

(71) Applicants: HYUNDAI MOTOR COMPANY, Seoul (KR); KIA CORPORATION, Seoul (KR); KOMOS.CO.,LTD, Hwaseong-si (KR)

(72) Inventors: Hoon Chang, Hwaseong-si (KR); Jong Wan Kim, Hwaseong-si (KR); Nam Cheol Kim, Hwaseong-si (KR); Han Mo Kang, Hwaseong-si (KR); Won Woo Chi, Yongin-si (KR); Jong Sun Jang, Hanam-si (KR)

(73) Assignees: HYUNDAI MOTOR COMPANY, Seoul (KR); KIA CORPORATION, Seoul (KR); KOMOS.CO.,LTD, Hwaseong-si (KR)

(21) Appl. No.: 18/953,682

(22) Filed: Nov. 20, 2024

(30) Foreign Application Priority Data
May 9, 2024 (KR) 10-2024-0061111

(51) Int. Cl. B60R 5/02; B60R 11/00; B62D 25/08

(52) U.S. Cl. CPC B60R 5/02; B62D 25/087; B60R 2011/0084

(57) ABSTRACT

A vehicular trunk reception structure includes a body have formed therein an interior space configured to receive and store an article, a board defining a bottom of the body, and a lifting device coupled to the board and lifted from the board in a drawing direction, the lifting device comprising a support, wherein the lifting device comprises at least one plate which is foldable and changeable in height and wherein the at least one plate has at least one first plate extension.

### CROSS-REFERENCE TO RELATED APPLICATION

This application claims under 35 U.S.C. § 119 (a) the benefit of priority to Korean Patent Application No. 10-2024-0061111 filed on May 9, 2024, the entire contents of which are incorporated herein by reference.

### TECHNICAL FIELD

The present disclosure relates to a vehicular trunk reception structure. More particularly, it relates to a vehicular trunk reception structure which is capable of separately receiving tools and articles according to size thereof and which has a reception space capable of being divided into subspaces depending on user needs, thereby allowing a narrow space in the trunk of a vehicle to be efficiently used.

### BACKGROUND

Generally, a trunk provided at the rear side of a vehicle is a space configured to accommodate various articles and baggage. The trunk is constructed to accommodate articles of various applications depending on the kind of vehicle such as a sedan and a Sport Utility Vehicle (SUV).

Specifically, a trunk reception cabinet provided in the trunk of a vehicle is configured to receive and store various articles such as various tools, vehicular articles, automotive supplies, emergency supplies, and cleaning supplies and further to store various different articles to be used in case of emergency.

In recent years, with the establishment of leisure culture, articles loaded into a vehicle are diversified and are put to practical use. Particularly, with the establishment of leisure culture, articles loaded into a vehicle are diversified and are increased in number, and the number of consumers who buy leisure vehicles having a large accommodation space is also increasing. How to construct an accommodation space of a vehicle efficiently depending on application of the vehicle and on needs in use serves as a factor that exerts significant influence on selection of a user. According to the size of an accommodation space, efficient and stable loading of articles must be considered. Furthermore, it is necessary to facilitate operation of loading and unloading relatively heavy articles.

Recently, as electric vehicles are universalized, the number of vehicles which are constructed such that a trunk is provided not only at the rear side of a passenger compartment but also at the front side of the passenger compartment may increase. Such a trunk may be referred to as a front trunk (or a frunk). In this case, a battery configured to drive the electrical vehicle is disposed below a passenger compartment, and a motor which has a very small volume compared to an engine is also disposed below the passenger compartment, thereby allowing both the front trunk and the rear trunk to be used as accommodation spaces.

The front trunk may be classified into an openable front trunk which is openable at the front surface and a non-openable front trunk which is not openable at the front surface.

Although the openable front trunk, which is constructed such that the front surface thereof is openable, has an enlarged accommodation space, the articles received in the accommodation space may move and thus generate noise because the front surface is openable, thereby causing a problem in that a user must buy an additional reception box or basket.

In addition, the non-openable front trunk is a trunk constructed such that all the surfaces of the trunk are not openable except the upper surface. Accordingly, because all the surfaces of the trunk are closed except the upper surface, articles are easily received in the trunk but there is a problem in that it is inconvenient for a user to load or unload baggage (particularly, a bulky of heavy baggage) because the front surface is closed.

The above information disclosed in this background section is only for enhancement of understanding of the background of the disclosure and therefore it may contain information that does not form the prior art that is already known in this country to a person of ordinary skill in the art.

### SUMMARY

The present disclosure has been made in an effort to solve the above-described problems associated with the prior art. An object of the present disclosure is to provide a vehicular trunk reception structure which is convertible so as to allow convenient use at the time of loading or unloading baggage.

Another object of the present disclosure is to provide a vehicular trunk reception structure capable of being used as a chair or a table for tea drinking which is used in leisure activities, such as a picnic, by virtue of the specific structure of the present disclosure.

Still another object of the present disclosure is to provide a vehicular trunk reception structure capable of allowing a user to efficiently use the interior space thereof.

The objects of the present disclosure are not limited to the above-mentioned objects, and other objects of the present disclosure, which are not mentioned above, will be clearly understood from the following descriptions of preferred embodiments and will be apparent from the preferred embodiments of the present disclosure. The above objects and other objects of the present disclosure are achieved by the means and combinations thereof disclosed in the claims.

In order to achieve the objects of the present disclosure, the vehicular trunk reception structure according to the present disclosure has the following constructions.

In one aspect, the present disclosure provides a vehicular trunk reception structure including a body having formed therein an interior space configured to receive and store an article, a board defining a bottom of the body, and a lifting device coupled to the board and lifted from the board in a drawing direction, the lifting device comprising a support, wherein the lifting device comprises at least one plate which is foldable and changeable in height.

In a preferred embodiment, the plate may have a quadrangular shape and may include at least one first plate extension provided at at least one of sides of the plate.

In another preferred embodiment, the first plate extension may be placed on the body.

In still another preferred embodiment, the first plate extension is coupled to the plate via a first hinge.

In yet another preferred embodiment, the plate may include a first plate positioned adjacent to the board, a second plate coupled to the first plate via a first hinge, and a third plate coupled to the second plate via a second hinge.

In still yet another preferred embodiment, a lower surface of the plate may be coupled to one end of the support of the lifting device.

In a further preferred embodiment, the support of the lifting device may include links which are positioned opposite each other and each of which is formed into an X shape so as to raise and lower the plate, a guide groove formed in a lower surface of the plate, an angle adjuster configured to allow one end of at least one of the links to be moved along the guide groove, a holding bar connected between the links positioned opposite each other, and a stopper positioned on the lower surface of the plate so as to hold the holding bar.

In another further preferred embodiment, the vehicular trunk reception structure may further include a slide member which is coupled to the board and to which the support is fixed, the slide member having formed therein a continuous groove to allow the links to be moved therealong.

In still another further preferred embodiment, the board may include a step portion projecting upwards.

In yet another further preferred embodiment, the vehicular trunk reception structure may further include an extending portion positioned at a front surface of the body and configured to be opened and closed.

In still yet another further preferred embodiment, the vehicular trunk reception structure may further include a basic pack net positioned at one of walls of the body and formed in a net shape, a rear net positioned at a front surface of the basic pack net, and a front net positioned at a front surface of the body to be opened and closed.

In another aspect, the present disclosure provides a vehicular trunk reception structure including a body have formed therein an interior space configured to receive and store an article, a board defining a bottom of the body, and a partition configured to divide an interior space in the body into subspaces.

In a preferred embodiment, the partition may include a first partition configured to divide the interior space in the body in a first direction, and a second partition configured to divide the interior space in the body in a second direction.

In another preferred embodiment, the first partition and the second partition are coupled to each other in a fitting manner.

### BRIEF DESCRIPTION OF THE DRAWINGS

The above and other features of the present disclosure will now be described in detail with reference to certain exemplary embodiments thereof, illustrated in the accompanying drawings which are given hereinbelow by way of illustration only, and thus are not limitative of the present disclosure, and wherein:

FIG. 1 is a view illustrating a vehicular trunk reception structure according to an embodiment of the present disclosure overall;

FIGS. 2A, 2B, and 2C are views illustrating the sequence in which the vehicular trunk reception structure according to an embodiment of the present disclosure is operated;

FIG. 3 is a view illustrating a coupling structure of the vehicular trunk reception structure;

FIG. 3A is an enlarged view illustrating the coupling structure of the vehicular trunk reception structure, shown in FIG. 3, according to an embodiment of the present disclosure;

FIG. 4 is a view illustrating a lifting device of the vehicular trunk reception structure according to an embodiment of the present disclosure when viewed from below;

FIG. 5 is a view illustrating the state in which a net unit is mounted to the vehicular trunk reception structure according to an embodiment of the present disclosure;

FIGS. 6, 6A, 6B, and 6C are views illustrating a fastening structure by which a partition is fastened to the vehicular trunk reception structure according to another embodiment of the present disclosure; and

FIG. 7 is a view illustrating the state in which the partition is mounted to the vehicular trunk reception structure according to another embodiment of the present disclosure.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes, will be determined in part by the particular intended application and use environment.

In the figures, the reference numbers refer to the same or equivalent parts of the present disclosure throughout the several figures of the drawing.

### DETAILED DESCRIPTION

Hereinafter, embodiments of the present disclosure will be described in detail with reference to the accompanying drawings. The embodiments of the present disclosure may be modified into various forms, and the scope of the present disclosure should not be construed as being limited to the following embodiments. These embodiments are provided so that this disclosure will be thorough and complete, and will fully convey the scope of the disclosure to those skilled in the art.

The term “part”, “unit” or “module” means a unit for performing at least one function or action, and may be realized by hardware or a combination of hardware.

The terminology used herein is for the purpose of describing particular embodiments only and is not intended to be limiting. As used herein, the singular forms “a,” “an” and “the” are intended to include the plural forms as well, unless the context clearly indicates otherwise.

It will be understood that, although the terms “first,” “second,” etc. may be used herein to describe various similar elements, these elements should not be construed to be limited by these terms. These terms are only used to distinguish one element from another.

Hereinafter, embodiments of the present disclosure will be described with reference to the accompanying drawings. In the description of the embodiments with reference to the accompanying drawings, the same or similar elements are assigned the same reference numerals irrespective of their reference numerals, and a redundant description thereof is omitted.

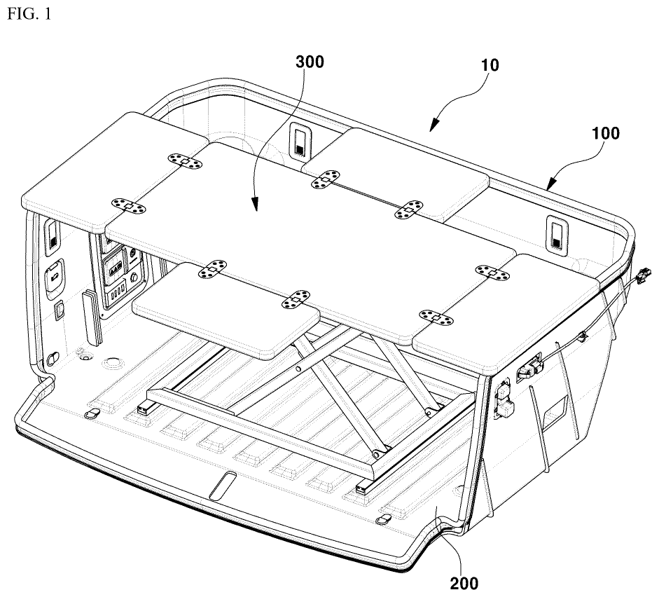

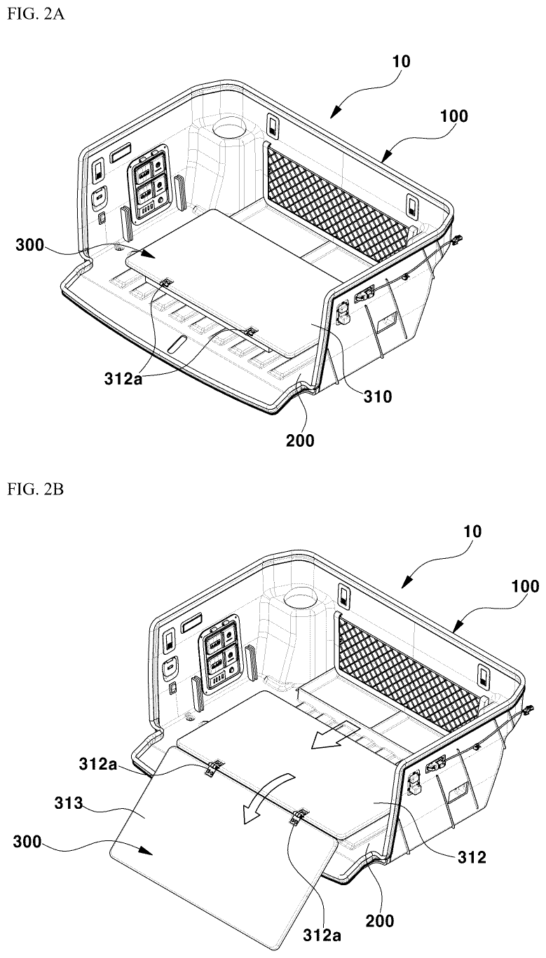

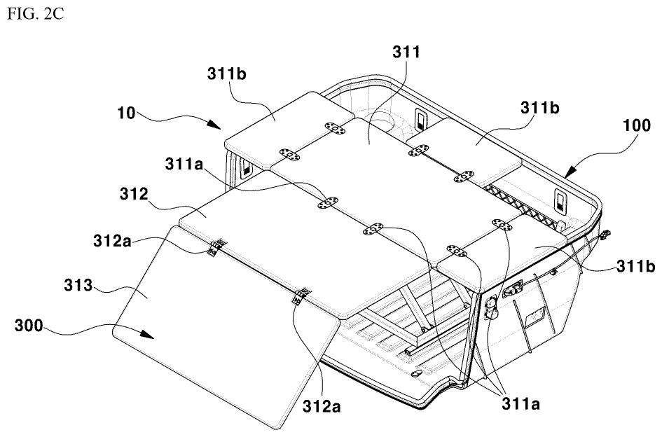

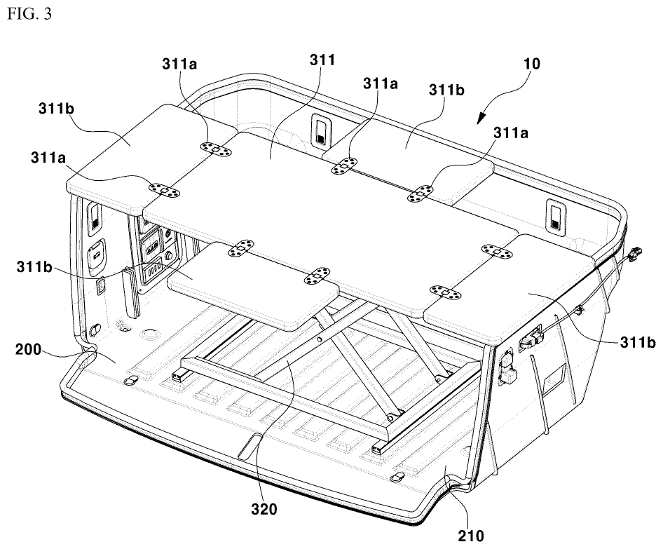

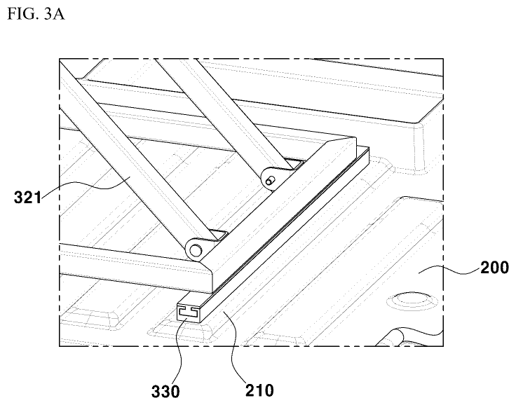

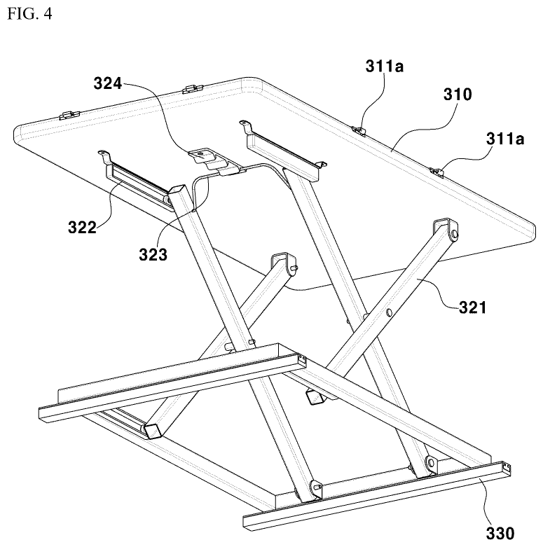

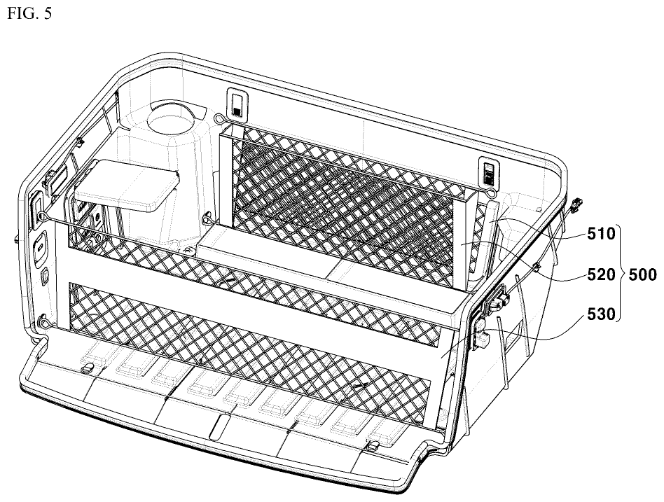

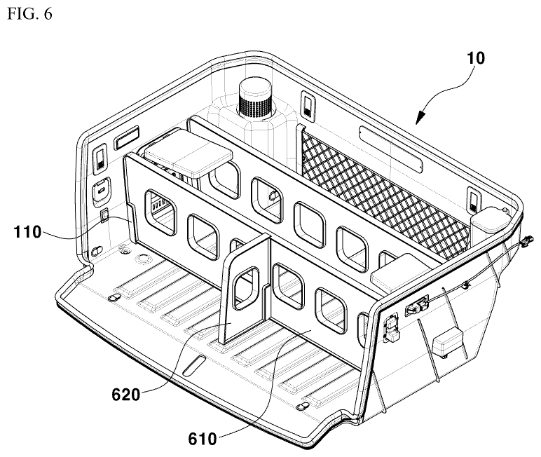

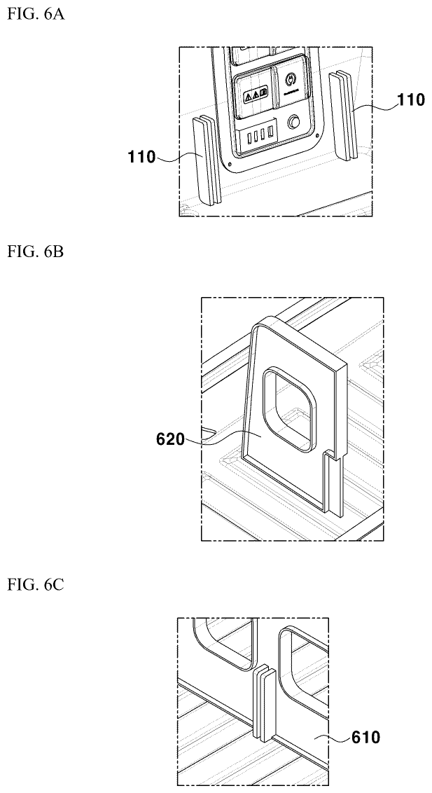

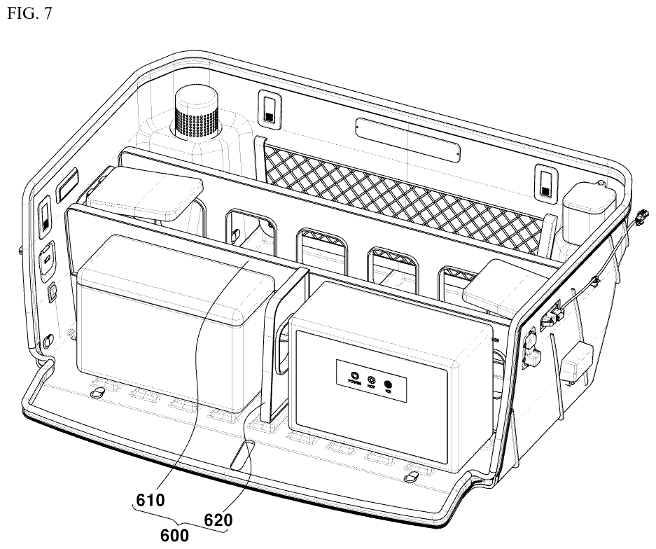

FIG. 1 is a view illustrating a vehicular trunk reception structure according to an embodiment of the present disclosure overall. FIGS. 2A, 2B, and 2C are views illustrating the sequence in which the vehicular trunk reception structure according to an embodiment of the present disclosure is operated. FIG. 3 is a view illustrating a coupling structure of the vehicular trunk reception structure, and FIG. 3A is an enlarged view illustrating the coupling structure of the vehicular trunk reception structure, shown in FIG. 3, according to an embodiment of the present disclosure. FIG. 4 is a view illustrating a lifting device of the vehicular trunk reception structure according to an embodiment of the present disclosure when viewed from below. FIG. 5 is a view illustrating the state in which a net unit is mounted to the vehicular trunk reception structure according to an embodiment of the present disclosure. FIGS. 6, 6A, 6B, and 6C are views illustrating a fastening structure by which a partition is fastened to the vehicular trunk reception structure according to another embodiment of the present disclosure. FIG. 7 is a view illustrating the state in which the partition is mounted to the vehicular trunk reception structure according to another embodiment of the present disclosure.

First, as illustrated in FIG. 1, the vehicular trunk reception structure 10 according to an embodiment of the present disclosure includes a body 100 having formed therein an interior space configured to receive and store articles, a board 200 defining the bottom of the body 100, and a lifting device 300 fastened to the board 200 and configured to be raised and lowered in a drawing direction with respect to the board 200.

Specifically, the body 100 of the vehicular trunk reception structure 10 has the interior space configured to receive articles and to allow the articles to be retrieved therefrom. Because the body 100 according to the embodiment of the present disclosure is positioned at the front side of a vehicle, the body 100 may be formed to have the same shape as the shape of the front portion of the vehicle. Generally, the body 100 according the embodiment of the present disclosure may be formed to have a shape different from the shape of the trunk positioned at the rear side of the vehicle. The body 100 according to the embodiment of the present disclosure may be defined by at least one partition wall, and the at least one partition wall may be opened so as to allow the articles received therein to be retrieved. The body 100 according to the embodiment of the present disclosure may be provided with a support protrusion 110 to which the partition to be described later is fastened.

The board 200 according to the embodiment of the present disclosure may be positioned at the bottom of the body 100, and may include at least one step portion 210 which extends toward the interior space. The step portion 210 of the board 200 according to the embodiment of the present disclosure may be provided so as to block movement of the articles received in the interior space during travel of the vehicle. Specifically, the board 200 comes into contact with the articles in the surface area of the step portion 210, thereby preventing movement of the articles received in the interior space.

The lifting device 300 of the vehicular trunk reception structure 10 according to the embodiment of the present disclosure may be coupled to the board 200, and may be lifted in the direction of the bonnet (e.g., hood). The lifting device 300 may include a plate 310, a support 320, and slide members 330.

Referring to FIGS. 1, 2A, 2B, and 2C, the lifting device 300 of the vehicular trunk reception structure 10 according to the embodiment of the present disclosure may include at least one plate 310 which includes a first plate 311, a second plate 312, and a third plate 313, which are stacked on one another and are folded and unfolded by means of hinges.

The first plate 311 of the plate 310 may be positioned closest to the board 200, and may be coupled to links 321 to be described later. The first plate 311 may include first hinges 311a.

The first plate 311 of the plate 310 may further include first plate extensions 311b which extend from respective sides of the rectangular shape. Specifically, the first plate extensions 311b of the first plate 311 may be connected to the four sides of the first plate 311 via the first hinges 311a, and may thus be folded toward the center of the first plate 311 and be unfolded outwards. Because the first plate extensions 311b are coupled to the first plate 311, the first plate 311 may be extended more than the plane area of the interior space in the body 100.

As illustrated in FIG. 1, the first plate extensions 311b may be placed and positioned on the upper edge of the body 100. Accordingly, the first plate extensions 311b may be lifted and then be placed on the body such that the first plate extensions 311b is used as a simplified table which may be used in leisure activities such as a picnic. Furthermore, because the first hinges 311a are coupled to the first plate extensions 311b, the first plate extensions 311b may be folded and stored when the first plate extensions 311b are not used. In other words, because the first plate 311 is extended by connecting the first plate extensions 311b to the first plate 311 by means of the first hinges 311a, the first plate 311 may be used a table for tea drinking. Meanwhile, because the first plate extensions 311b are folded on the first plate 311 and are stored when the first plate 311 is not used, the reception structure may be easily assembled by a user.

The first plate 311 of the plate 310 according to the embodiment of the present disclosure, which is formed into the shape of a large plate, may allow the goods stored in the interior space in the body 100 to be easily sild outwards and thus withdrawn therefrom. In order to slide the articles, one surface of the first plate 311 may be formed into a flat shape without a curved portion or irregularity.

Furthermore, the first plate 311 of the plate 310 according to the embodiment of the present disclosure may be positioned closest to the board 200, and may be coupled to the links 321. The first plate 311 may include the first hinges 311a. The first plate 311, which is formed into the shape of a large plate, may allow the goods stored in the interior space in the body 100 to be easily sild outwards and thus withdrawn therefrom. In order to slide the articles, one surface of the first plate 311 may be formed into a flat shape without a curved portion or irregularity.

The second plate 312 of the plate 310 according to the embodiment of the present disclosure may be connected to the first hinges 311a, and may be formed into the same shape as the first plate 311. The second plate 312 may be formed so as to allow the articles stored in the interior space to be slid outwards, and one surface of the second plate 312 may be formed into a flat shape like the first plate 311. The first hinges 311a and the second hinges 312a may be coupled to the second plate 312. The first plate 311 and the second plate 312 may be stacked on the board 200, and may be unfolded outwards. The second plate 312 may be rotated outwards about the first hinges 311a.

The third plate 313 of the plate 310 according to the embodiment of the present disclosure may be provided with second hinges 312a in order to be connected to the second plate 312. The third plate 313 may be formed to have the same shape as the first plate 311 and the second plate 312, like the first plate 311 and the second plate 312, and may be formed to have a flat shape so as to allow the articles stored in the interior space to be easily slid outwards. The third plate 313 is the plate that is positioned at the highest level among the first plate 311, the second plate 312 and the third plate 313. The third plate 313 may be positioned close to the bonnet, and may be positioned at the distal end of the trunk reception structure when the plate 310 is unfolded.

However, the third plate 313 is not limited to the plate that is positioned at the highest level, and the second plate 312 may be positioned at the highest level and be adjacent to the bonnet depending on the manner in which a user folds the plate 310. By virtue of the first hinges 311a and the second hinges 312a, any of the second plate 312 and the third plate 313 may be positioned closest to the bonnet depending on a direction in which a user rotates the plate 310. In this way, the plate 310 may be freely folded and unfolded in any direction in which a user can conveniently fold and unfold the plate 310.

Next, the support 320 of the lifting device 300 of the vehicular trunk reception structure 10 according to an embodiment of the present disclosure may be coupled to the bottom surface of the first plate 311 so as to vertically raise the plate 310 toward the bonnet. The support 320 may include the links 321, an angle adjuster 322, a holding bar 323, and a stopper 324.

Specifically, referring to FIGS. 3 and 4, the links 321 of the support 320 of the lifting device 300 according to an embodiment of the present disclosure may be fastened to the board 200 and may be disposed so as to form an X shape. Accordingly, the first plate 311 may be raised or lowered by increasing or decreasing the intersection angle of the X shape. Although this embodiment describes that the first plate 311 is raised, the second plate 312 and the third plate 313 which are coupled to the first plate 311 may also be raised. The links 321 may further include a rectangular frame close to the board 200, and the X-shaped links may be vertically disposed on the rectangular frame.

The links 321 may be coupled to the slide members 330 positioned on the board 200. The links 321 may be coupled to the at least one step portion 210 of the board 200 which are linearly disposed, and may be vertically disposed on the board 200.

As described above, the links 321 may be vertically erected into the X shape, and may be positioned at opposite locations, thereby stably supporting the first plate 311 at opposite sides.

One of the X-shaped links 321, which are positioned opposite each other, may be coupled at one end thereof to the board 200 and at the other end to the first plate 311. The holding bar 323 may be disposed between the opposed links 321 so as to connect the opposed links 321 to each other.

The support 320 may further include the angle adjuster 322 coupled to the lower surface of the first plate 311. The other end of each of the X-shaped links 321 may be coupled to the angle adjuster 322, and the other end of the link 321 may be inserted into a guide hole formed in the angle adjuster 322 so as to be moved horizontally. The angle of the link 321 may be adjusted in this way, thereby making it possible to adjust the height of the first plate 311. The stopper 324 may be mounted on the lower surface of the first plate 311. When the holding bar 323 catches in one of the grooves formed in the stopper 324, the links 321 and the first plate 311 may be stably supported.

Next, the slide members 330 of the lifting device 300 according to an embodiment of the present disclosure may be coupled to the step portion 210 of the board 200, and may be disposed parallel to each other so as to stably support the link 321. Specifically, a continuous groove may be longitudinally formed in each of the sliding members 330 of the lifting device 300, and a slide protrusion may be inserted into the continuous groove. The link may be mounted to the board when the slide protrusion is inserted into the continuous groove, and the link may be separated from the board when the slide protrusion is separated from the continuous groove.

Specifically, one surface of the slide member 330 may be coupled to the step portion 210 of the board 200, and the other surface of the slide member 330 that is positioned opposite the one surface may be coupled to the rectangular frame. The frame may be coupled to and separated from the continuous groove in the slide member 330. Accordingly, when the slide members 330 are not used by a user, the slide member 330 may be separated from the board 200.

The vehicular trunk reception structure 10 according to an embodiment of the present disclosure may include an extending portion (not shown) which is positioned at the front surface of the body 100 so as to be selectively opened. Specifically, the extending portion of the vehicular trunk reception structure 10 may be the at least one wall which is configured to be opened and closed. In other words, the extending portion may be received in the body when the extending portion is not used, and may be opened so as to serve as a rail for transfer of articles when the extending portion is used.

FIG. 5 is a view illustrating the state in which the net unit 500 is mounted to the vehicular trunk reception structure according to an embodiment of the present disclosure. Referring to FIG. 5, the vehicular trunk reception structure according to the embodiment of the present disclosure may further include the net unit 500 having a net shape which is mounted in the interior space of the body 100 so as to receive articles having certain applications. The net unit 500 may include a basic pack net 510, a rear net 520, and a front net 530 which are classified according to installation position.

The basic pack net 510 of the net unit 500 according to the embodiment of the present disclosure may be positioned at the rear side of the body 100 so as to utilize the interior space in the body 100, thereby allowing various articles to be easily taken out or received therein.

The rear net 520 of the net unit 500 may be formed to have a basket-shaped net structure so as to receive various articles having a larger volume than the articles received in the basic pack net 510.

The front net 530 of the net unit 500 may be provided in order to prevent articles from falling down forwards during travel of the vehicle, when the vehicle is stopped or when the extending portion is opened to take the articles out.

FIGS. 6, 6A, 6B, and 6C are views illustrating a fastening structure by which the partition is fastened to the vehicular trunk reception structure according to another embodiment of the present disclosure. FIG. 7 is a view illustrating the state in which the partition is mounted to the vehicular trunk reception structure according to another embodiment of the present disclosure.

Referring to FIGS. 6, 6A, 6B, 6C, and 7, the partition 600 of the vehicular trunk reception structure according to another embodiment of the present disclosure may include a first partition 610 configured to divide the interior space in the body 100 in a first direction, and a second partition 620 configured to divide the interior space in a second direction.

Referring to FIGS. 6, 6A, 6B, and 6C, the first partition 610 of the partition 600 may be fitted into the support protrusion 110 of the body 100 to divide the interior space, thereby arranging the articles received in the interior space without movement of the articles. The first partition 610 may have formed therein a groove into which the second partition 620 is fitted.

Like the first partition 610, the second partition 620 of the partition 600 may be configured to divide the interior space in the body 100 in the second direction, thereby arranging the articles received in the interior space without movement of the articles. The second partition 620 may be fitted into the groove in the first partition 610.

As illustrated in FIG. 7, the vehicular trunk reception structure according to the embodiment of the present disclosure may be configured such that the interior space in the body 100 is divided into subspaces by the partition 600 so as to allow a cabinet, a refrigerator, a warmer cabinet and the like to be positioned in the subspaces. The subspaces may receive various articles, such as an air injector, a detachable Bluetooth speaker, a UV sterilizer, a collapsible scooter and a rotary reception box.

One of the walls of the body 100, which define the interior space, may be provided with a connector, a USB port, a lamp, a lamp switch configured to activate the lamp, an emergency escape lever, a shopping bag hook, an ON/OFF switch and the like, thereby realizing a vehicular trunk reception structure capable of fulfilling a lot of functions.

As described above, the vehicular trunk reception structure 10 according to an embodiment of the present disclosure may not only be used to load articles into the trunk but also be used as a rail by coupling the lifting device 300 to the body 100 when large or heavy baggage is unloaded. Furthermore, the first plate extensions 311b may be connected to the first plate 311 via the first hinges 311a so as to be used as a table for tea drinking, and may be folded when not in use. Accordingly, the vehicular trunk reception structure according to the embodiment of the present disclosure may be embodied as a chair or a table for tea drinking in leisure activities, such as a picnic.

In addition, an embodiment of the present disclosure may provide a vehicular trunk reception structure capable of storing various articles by dividing the interior space in the reception structure into subspaces and thus capable of realizing a lot of functions using the various articles.

By virtue of the above-described construction of the embodiments of the present disclosure, the present disclosure offers the following effects.

The present disclosure provides a vehicular trunk reception structure which is convertible into a rail so as to allow convenient use at the time of loading or unloading baggage.

Furthermore, the present disclosure provides a vehicular trunk reception structure capable of being used as a chair or a table for tea drinking which is used in leisure activities, such as a picnic, by virtue of the extendable plate structure.

Finally, by dividing the interior space of the body into subspaces, the present disclosure enables a user to easily put an article into the interior space in the body or to easily take the article out of the interior space, thereby allowing the interior space to be variously used.

The detailed description is illustrative of the present disclosure. Also, the above description is intended to illustrate and explain preferred embodiments of the present disclosure, and the present disclosure may be implemented in various other combinations, modifications, and environments. In other words, the present disclosure may be changed or modified within the scope of the concept of the disclosure disclosed herein, within the equivalent scope of the disclosure, and/or within the skill and knowledge of the art. The described embodiments illustrate the best state of the art to implement the technical idea of the present disclosure, and various changes may be made thereto as demanded for specific applications and uses of the present disclosure. Accordingly, the detailed description is not intended to limit the present disclosure to the embodiments. Also, the appended claims should be construed as encompassing such other embodiments.

What is claimed is:

1. A vehicular trunk reception structure comprising:
a body having formed therein an interior space configured to receive and store an article;
a board defining a bottom of the body; and
a lifting device coupled to the board and lifted from the board in a drawing direction, the lifting device comprising a support,
wherein the lifting device comprises at least one plate which is foldable and changeable in height and wherein the at least one plate has at least one first plate extension.

2. The vehicular trunk reception structure of claim 1, wherein the plate has a quadrangular shape and wherein the at least one first plate extension is provided at at least one side of the plate.

3. The vehicular trunk reception structure of claim 1, wherein the first plate extension is placed on the body.

4. The vehicular trunk reception structure of claim 1, wherein the first plate extension is coupled to the plate via a first hinge.

5. The vehicular trunk reception structure of claim 1, wherein the plate comprises:
a first plate positioned adjacent to the board;
a second plate coupled to the first plate via a first hinge; and
a third plate coupled to the second plate via a second hinge.

6. The vehicular trunk reception structure of claim 1, wherein a lower surface of the plate is coupled to one end of the support of the lifting device.

7. The vehicular trunk reception structure of claim 1, wherein the support of the lifting device comprises:
links which are positioned opposite each other and each of which is formed into an X shape to raise and lower the plate;
a guide groove formed in a lower surface of the plate;
an angle adjuster configured to allow one end of at least one of the links to be moved along the guide groove;
a holding bar connected between the links positioned opposite each other; and
a stopper positioned on the lower surface of the plate so as to hold the holding bar.

8. The vehicular trunk reception structure of claim 7, further comprising a slide member which is coupled to the board and to which the support is fixed, the slide member having formed therein a continuous groove to allow the links to be moved therealong.

9. The vehicular trunk reception structure of claim 1, wherein the board comprises a step portion projecting upwards.

10. The vehicular trunk reception structure of claim 1, further comprising an extending portion positioned at a front surface of the body and configured to be opened and closed.

11. The vehicular trunk reception structure of claim 1, further comprising:
a basic pack net positioned at one of walls of the body and formed in a net shape;
a rear net positioned at a front surface of the basic pack net; and
a front net positioned at a front surface of the body to be opened and closed.

12. A vehicular trunk reception structure comprising:
a body having formed therein an interior space configured to receive and store an article;
a board defining a bottom of the body; and
a partition configured to divide an interior space in the body into subspaces.

13. The vehicular trunk reception structure of claim 12, wherein the partition comprises:
a first partition configured to divide the interior space in the body in a first direction; and
a second partition configured to divide the interior space in the body in a second direction.

14. The vehicular trunk reception structure of claim 13, wherein the first partition and the second partition are coupled to each other in a fitting manner.
